(19) United States
(12) Patent Application Publication
(10) Pub. No.: US 2015/0202557 A1
(43) Pub. Date: Jul. 23, 2015

(54) METHOD FOR PRODUCING A FILTER ELEMENT

(71) Applicant: AG+ APS, Sejeroe (DK)

(72) Inventor: Jens Steen Olsen, Havdrup (DK)

(21) Appl. No.: 14/373,659

(22) PCT Filed: Jan. 28, 2013
(86) PCT No.: PCT/DK2013/050026

§ 371 Date: Jul. 22, 2014

(30) Foreign Application Priority Data
Jan. 26, 2012 (DK) PA201200075
Jun. 8, 2012 (DK) PA 2012 70312

(51) Int. Cl. B01D 46/00; B05D 1/12

(52) U.S. Cl. CPC B01D 46/0001; B05D 1/12

(57) ABSTRACT

A method is disclosed for producing a filter element including metal or metal oxide particles adhered to the fibers of the fiber element. In an embodiment, the filters may be used in a ventilation system for reducing the amount of microorganisms in the air.

INTRODUCTION

The present invention relates to a method for producing a filter element having metal or metal oxide particles adhered to the fibers of the fiber element. The filters may be used in ventilation systems for reducing the amount of microorganisms in the air.

### BACKGROUND ART

The amount of microorganisms in the air has an influence of the well-being of humans. If the amount is too high the mucosa will become inflamed. Also, the microorganism may be pathogenic thereby causing development of a disease, such as allergy especially observed in children.

Korean patent application No. KR20060116770 discloses a clean bench. In order to purify the air flowing into the bench one or more first filters are installed in an air injection hole. The air in the circulation is contacted with a second filter and subsequently with a photo catalytic element containing titanium dioxide. An ultra violet ray lamp irradiates the photo catalytic element to clean the air. Optionally, also a second element containing nanosilver particles may be installed to enhance the sterilizing process.

The purpose of the present invention is to reduce the amount of microorganisms in the spaces or compartments humans are present in. Examples of such spaces are homes, working spaces, cars, trains, etc. Especially, the present invention addresses the problem of improving existing ventilations systems comprising a traditional filter.

### DISCLOSURE OF THE INVENTION

The present invention relates to a method for producing a filter element having metal or metal oxide particles adhered to the fibers of the filter element, wherein the filter element is sprayed or brushed with a media containing the metal or metal oxide particles.

In existing ventilation systems filters of a conventional type are generally available from the producers. As an example, the filter in ventilations systems or air conditioning systems in cars and trucks are available from the maker of the vehicle. Such filters will during use become infiltrated with dirt, pollen, leaves and other kind of organic material. The organic material will serve as nutrition for microorganisms, such as bacteria, molds, yeasts, etc. The microorganisms will be conveyed through the ventilation system to the compartment where a human is present and expose the person for a health risk. The present invention suggests treating the conventional filters with a media containing the metal or metal oxide particles. By this treatment, the metal or metal oxide particles will be adhered to the fibers of the fiber element. When air is conveyed through the filter in a ventilation system, the amount of microorganisms in the air will be reduced or eliminated. In this way the person present in the compartment will be exposed for less health risk from microorganisms.

In an aspect of the invention the method comprises the use of metal or metal oxide particles having a mean diameter of 10⁻⁶m or below, such as micronized silver particles. It is believed that a size below 10⁻⁶m of the particles results in a surface area, which is particularly active in the combat of the microorganisms. In the present invention the filter element having metal or metal oxide particles adhered to the fibers of the filter element is intended to be included in a ventilation system comprising a plurality of channels conveying air, one or more compartments, that need to be ventilated and at least one fan for transporting the air. Examples of compartments include living rooms, working spaces, airplane cabins, interiors of vehicles, such as trucks, cars, and ships.

It is presently believed that silver nanoparticles interact with the outer membrane of microorganisms, causing structural changes that lead to degradation and eventually death of the microbe.

The metal or metal oxide particles may be selected from a large group of components readily available to the person skilled in the art. In a preferred aspect the metal or metal oxide particles are selected from the group comprising micronized silver particles, zinc particles, cupper particles, silver particles, iron oxide particles, titanium dioxide particles, zinc oxide, aluminum oxide, or a mixture thereof. Presently preferred metal and metal oxide particles are micronized silver particles.

The metal or metal oxide particles generally have a mean diameter at or below 10⁻⁶m, such as below 10⁻⁷m, suitably below 10⁻⁸m. Generally, the metal or metal oxide particles have a diameter above 0.30 nm, such as above 0.6 nm, suitably 1 nm.

The metal or metal oxide particles are preferably of a purity over 50%, suitable above 60%, such as above 70%, preferably above 80% such as 90%. In a certain embodiment the metal or metal oxide particles, such as the micronized silver particles are prepared of silver having a purity of at least 99%, such as at least 99.9%. In a most preferred aspect the micronized silver particles are prepared of silver having a purity of about 99.9%. Present together with the micronized silver may be other particles such as sub-micron zinc oxide, aluminum oxide and/or boron nitride particles.

In certain embodiments of the invention the metal or metal oxide particles are present in the surface of a carrier. The carrier may be prepared of any suitable material, such as glass, polymer, ceramics, or plant fibers. In a preferred aspect the carrier is hollow, such as a hollow glass particle. The mean diameter of the carrier is suitable above 1 my, such as above 5 μm but usually below 150 μm. In a certain aspect 90% of the weight of the particles is within the mean diameter range of 0.5 μm-15 μm. The hollow carrier may be designed to achieve a density compatible with the media containing the metal or metal oxide particles. In another aspect of the invention the carrier is designed with a lower density than the density of the media to allow for the particles to be transported to the surface by gravity. In an aspect of the invention the density is in the range of 1 to 4 g/cm³, such as between 2 and 3 g/cm³.

The metal or metal oxide particles, optionally present on a carrier, may be formulated into a paint, lacquer, varnish, or another media before application. The media is preferably of a type admitting vapor to diffuse through the cured media, e.g. a so-called diffusion-open paint.

The metal or metal oxide particles may be incorporated in at least the surface of the filter used in the ventilation system. In an embodiment of the invention an ultraviolet (UV) source is provided in proximity to the surface provided with metal or metal oxide particles. The presence of the UV source improves the effectiveness of the filter, thereby increasing the amount of microorganisms being removed. UV light has a wavelength in the range of 10 nm to 520 nm.

In an embodiment, the metal or metal oxide particles are present in a fiber, such as a ceramic, polymeric, glass or plant fiber. The metal or metal oxide particles may be added to the melt before production of the glass or polymeric fibers, or the metal or metal oxide may be applied to the fibers after the production thereof. The fibers may be used in the media used to treat the filter.

In a certain application of the invention it relates to a filter mat or element, i.e. a porous structure mainly composed of a plurality of inter-connected fibers, where the metal or metal oxide particles have been added to the filter element by spraying or brushing with a media containing the metal or metal oxide particles.

The media suitably comprises a binding agent ensuring the metal or metal oxide particle to be adhered to the fibers of the fiber element. Suitably, the media is a paint or varnish having metal or metal oxide particles incorporated. The filter element may be used in air ventilation systems, including air circulation, air heating, air cooling, air humidity, and air conditioning.

The binder used in the media may any suitable substance that can cause adhesion of the particles to fibers of the filter. In general the binder is a liquid component, which solidifies after application of the media to the filter to adhere the particles to the filter. Examples of binders are poly(meth)acrylic acid, poly(meth)acrylic acid esters, linseed oil, pure acrylic polymers, polystyrene, styrene/acrylate copolymers, polyvinyl acetate, methylcellulose, ethylcellulose, vinyl acetate copolymers with acrylic acid esters, vinyl acetate copolymers with dibutyl maleate, vinyl acetate copolymers with vinyl esters of fatty acids, acacia, alginic acid, carboxymethylcellulose, sodium compressible sugar, ethylcellulose gelatin, liquid glucose, metylcellulose, povidone, pregelatinized starch.

A suitable polymer dispersion as a binder has been found to be a pure acrylic dispersion. In another aspect of the invention a suitable binder is a copolymer of vinyl acetate and vinyl ester of a fatty acid.

The media may comprise further conventional excipients such as conventional dispersing aids, anti-settling agents, water-binding agents, corrosion inhibitors, defoamers, thickeners, pH adjusters, fillers, detergents, and pigments.

The media may contain the individual components in suitable amounts and relative proportions. In a preferred aspect, the amount of metal or metal oxide particle is present in the media in an amount of 0.1 to 10% by weight, more preferred in an amount of 0.1% to 1%. The binder may be present in the media in an amount sufficient for ensuring adherence of the particles to the fibers. Usually, an amount of 5-50% by weight, such as 15-30% by weight is suitable. Since the media may have a tendency to foam it is desirable to include a defoamer, such as a mineral oil. Other defoamers suitably include vegetable oils, white oil, hydrophobic silica, and waxes. The defoamer may be included in the formulation of the media in an amount of 0.01 to 5% by weight. Water is used alone or in combination with one or more co-solvents. The cosolvent may be selected among ethanol, ethylene glycol, propylene glycol, acetone, methylethylketone, diethylether, pentane, hexane, heptane, or octane etc. Water is used in the media in an amount to obtain a suitable viscosity. Suitable amounts of water include 20-95% water.

The media may be applied on the fibers of the conventional filter in any suitable way, including brushing and spraying. When the media is intended for spraying on the fibers, it may be supplied in a contained suitable for spraying, such as a pressurized container. Alternatively, the media may be supplied to the used in a container with instructions to atomize the media through a suitable nozzle. The media may be atomized by pressurized air, such as a spray gun or a spray brush. In the alternative, the media may be applied by a brush to the surface of the filter. After application of the media, the media is usually allowed to cure, thereby attaching the metal or metal oxide particles to the fibers of the fiber.

In a certain aspect of the invention the inner surface of an inlet of an air conveying channel, which is a part of a ventilation system, may be provided with a filter containing metal or metal oxide particles by e.g. application of a media, such as a paint comprising metal or metal oxide particles on the filter. When air is transferred through the conveying channel into a room of the ventilation system, it will be brought into contact with the metal or metal oxide particles before entering the room. Also the outlet may be provided with metal or metal oxide particles in a similar way. Hereby, the amount of microorganisms that might be suspended in the air is reduced. To enhance the contact between microorganisms suspended in the air flow and the inner surface of the channel, the channel may further be provided with structures providing for a higher contact between the air and the surface of the channel. The structures may be provided to deflect the air flow.

The inlet and/or the outlet may also be provided with a filter, which has adhered metal or metal oxide particles. The filter is installed to ensure that most, preferably the entire amount of air flow is filtered through the filter, thereby reducing the amount of microorganisms in the air. Furthermore, the inner surface of the channel may be provided with metal or metal oxide particles in a length of at least 20 cm, such as at least 1 m from the inlet or the outlet.

The structure may in itself be provided with metal or metal oxide particles. To enhance the efficiency the channel may be provided with a lamp providing UV radiation, e.g. radiation in the range of 400 to 520 nm.

When the invention is applied to a ventilation system, it may be used in surgeon rooms or other rooms requiring high degrees of cleanness. Other applications include cars, tractors, trains, private homes, trucks, air-condition for apartments and hotels, air planes, working spaces, vacuum cleaners. The filters of the invention may also be used as pollen filter in cars and trucks.

### EXAMPLE 1

### Inhibition of Mold Growth

Two cultures of the commonly occurring molds Cladosporium and Stachybotrys were cultured in the dark at 25 degrees on fungal substrates applied either 2 mL of sterile water or 2 mL of a silver particles solution, and then subject to filter paper (Whatman).

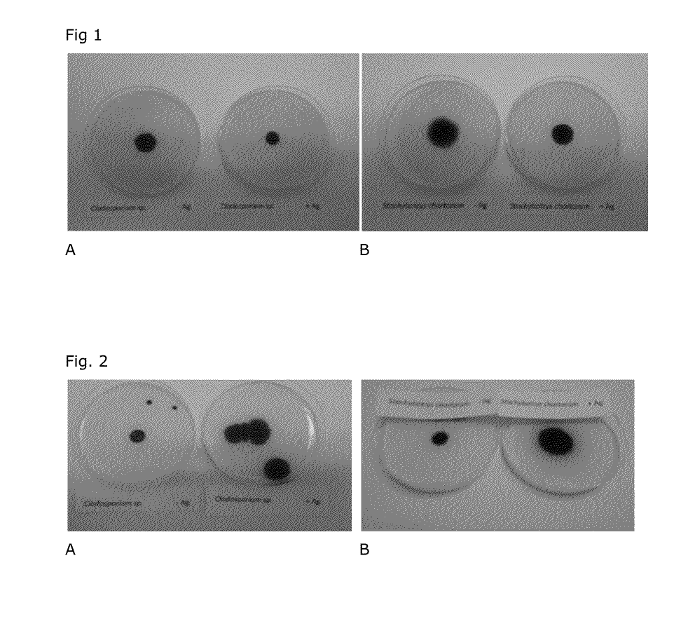

In a first experiment, the mold developed as a single inoculation in the center of the filter paper placed on top of a nutrient-rich medium (oat meal agar) and then cultured for 7 days. Results are shown in FIGS. 1A and 1B.

Similar molds were in the second experiment grown in a less nutrient-rich medium (minimal medium) for 14 days. Both tests can be considered worst case scenarios due to the rich substrates and high temperature. The results are shown in FIGS. 2A and 2B.

FIG. 1 shows that the addition of 2 mL of silver particles solution has growth inhibitory effect on both Cladosporium and Stachybotrys cultures, although the fungi have been awarded optimal growth conditions in a very nutrient-rich substrate. FIG. 2 shows similarly a clear growth inhibitory effect when cultures are grown for fourteen days at a less nutritious, but still sugar containing substrate.

In conclusion the silver particles have a clear growth inhibiting effect on the frequently occurring molds Cladosporium and Stachybotrys. It is noted that the inhibiting effect is most pronounced on the minimal media. This fact suggest that the effect will be stronger on more natural less nutrition-rich substrates such as humid filters only containing a small amount of organic material.

### EXAMPLE 2

### Media Containing Silver Particles

Composition

0.5% by weight micronized silver particles

0.2% by weight of mineral oil defoamer

20% by weight of polyacrylic dispersion

Water to 100% by weight.

The components are mixed together and a dispersion is obtained, which is sufficiently stable to allow for spraying a car pollen filter. After spraying of the filter with an air brush the media was allowed to cure for 1 hr at ambient temperature, so the micronized silver particles could solidify on the fibers of the filter.

1. A method for producing a filter element including metal or metal oxide particles adhered to fibers of the filter element, the method comprising:
spraying or brushing the filter element with a media containing the metal or metal oxide particles.

2. The method according to claim 1, wherein the metal or metal oxide particles include a mean diameter of 10⁻⁶m or below.

3. The method according to claim 1, wherein the metal or metal oxide particles include. micronized silver particles, zinc particles, cupper particles, iron oxide particles, titanium dioxide particles, zinc oxide, aluminum oxide, or
a mixture of at least two of micronized silver particles, zinc particles, cupper particles, iron oxide particles, titanium dioxide particles, zinc oxide, and aluminum oxide.

4. The method according to claim 3, wherein the metal and metal oxide particles are micronized silver particles.

5. The method according to claim 1, wherein purity of the metal or metal oxide used in the particles is 99% or above.

6. The method according to claim 1, wherein the metal or metal oxide particles are present in a surface of a carrier.

7. The method according to claim 1, wherein the metal or metal oxide particles are present on the filter element in an inlet part or outlet part of an air circulation system.

8. The method according to claim 1, wherein the metal or metal oxide particles are incorporated in media comprising a binding agent.

9. The method according to claim 8, wherein the binding agent is an acrylic dispersion.

10. The method according to claim 8, wherein the media incorporating the metal or metal oxide particles is aqueous.

11. The method according to claim 8, wherein the media comprises 15-30% of an acrylic dispersion.

12. The method according to claim 8, wherein the metal or metal oxide particles is present in the media in an amount of 0.1 to 10% by weight.

13. The method according to claim 1, wherein the metal or metal oxide particles are present on at least a surface of the filter element used in a ventilation system.

14. The method according to claim 13, wherein the ventilation system is provided with structures deflecting air flow.

15. The method according to claim 1, wherein an UV source is provided in proximity to a surface provided with metal or metal oxide particles.

16. The method according to claim 1, wherein the filter element is provided in a system comprising a plurality of channels conveying air, one or more compartments provided with an inlet channel and an outlet channel, and at least one fan for transporting the air, wherein at least one of the one or more compartments includes a room, a working space, an airplane cabin, an interior of a vehicle, such as a truck, a car, and a ship, or a vacuum cleaner.

17. The method according to claim 2, wherein the metal or metal oxide particles include micronized silver particles, zinc particles, cupper particles, iron oxide particles, titanium dioxide particles, zinc oxide, aluminum oxide, or
a mixture of at least two of micronized silver particles, zinc particles, cupper particles, iron oxide particles, titanium dioxide particles, zinc oxide, and aluminum oxide.

18. The method according to claim 17, wherein the metal and metal oxide particles are micronized silver particles.
